(19) United States
(12) Patent Application Publication
(10) Pub. No.: US 2018/0319613 A1
(43) Pub. Date: Nov. 8, 2018

(54) TRACTION TENSIONING MACHINE

(71) Applicant: BUTECH, INC., Salem, OH (US)

(72) Inventor: John R. Buta, Salem, OH (US)

(73) Assignee: BUTECH, INC., Salem, OH (US)

(21) Appl. No.: 15/970,069

(22) Filed: May 3, 2018

Related U.S. Application Data
(60) Provisional application No. 62/501,257, filed on May 4, 2017.

(51) Int. Cl. B65H 29/12; F16H 7/12; B65H 20/06; B65H 23/18

(52) U.S. Cl. CPC B65H 29/12; F16H 7/1263; B65H 5/023; B65H 23/18; B65H 20/06

(57) ABSTRACT

A traction tensioning device which has one or more upper chain assemblies driven by an upper sprocket pulley and one or more lower chain assemblies driven by a lower sprocket pulley. Each of the upper and lower chain assemblies has a plurality of pads mounted to the chain assemblies. The upper chain assembly is mounted to a movable platen. The lower chain assembly is mounted to a fixed platen. The upper chain assembly and the movable platen are raised and lowered with respect to the lower chain assembly thereby creating a tension on a strip of material passing between the upper and lower chain assemblies.

### CLAIM OF PRIORITY

This application claims priority from provisional application Ser. No. 62/501,257, filed on May 4, 2017, the entirety of which is incorporated by reference herein.

### BACKGROUND OF THE DISCLOSURE

In the field of processing metal coils, ferrous and non-ferrous coils are unwound, modified, and then either rewound or cut to length. There are zones in any given process, wherein the strip needs to be in tension for proper operation. For example, there needs to be holdback tension as a coil is unwound. This tension prevents clock-springing of the coil which would create surface scratches on the strip. Tension is also used to wind tight wraps at the recoiler. Tight coils are more stable for coil storage and handling. Line tension also helps to keep the strip on track as it advances through the process line. Typically these tension levels are relatively low when compared to the yield strength of the strip.

High tension levels are typically used to improve strip parameters, such as improved flatness, or reduction of strip camber. High strip tension has been found to break up strip surface scale which results in more efficient pickling of the strip. These tension levels are very close to the yield strength of the strip and at times are high enough to yield the strip in a controlled manner.

Traditionally, high strip tensions are achieved by wrapping the strip around bridle rolls 10, 12; as shown in FIG. 1.

The entry group of bridle rolls 10 holds back against the exit bridle rolls 12 thus creating a high tension zone 14 between the bridle rolls. The cumulative wrap angle of the strip 15 around the bridle rolls and the friction co-efficient between the bridle roll surface and the strip is the mechanism that enables sufficient torque to be applied by the bridle roll drives. For practical purposes, there are limits to the range of strip thickness that can be processed on bridle rolls.

Other devices have also been developed for creating high tension in thicker strip. Referring to FIG. 2, one existing approach is a stretching machine 16 wherein the strip is stopped and clamped between two opposed stretcher heads 17, 18 and then one of the heads is moved axially in relation to the other fixed head resulting in strip tension.

This approach can create enough tension to yield and plastically stretch the material, but because of the need to stop the strip for each stretch, the time to process a coil is increased and productivity suffers.

Referring to FIG. 3, still another existing approach for creating high tension in thicker strip is to use traction devices. Typically two traction machines 20, 22 are used, and a high tension zone 24 is created between them. In each machine, the strip 26 of material is squeezed between an upper and lower set of traction cleats 27, 29. The exit machine 20 moves the strip 26 slightly faster than the entry machine 22, and thus the strip 26 is tensioned and elongated based on that speed difference. Generally these traction style machines are expensive and their requisite maintenance is expensive and time consuming.

FIGS. 4 and 5 depict a typical traction machine 27 as currently used in the market place. The traction tensioning machine 27 is designed to process a range of strip thickness. This requires the gap between the upper and lower “cleats” 28, 30 to be variable. This is accomplished by moving the upper drive pulley in relation to the lower pulley. This in turn necessitates drive shafts with u-joints or slipper joints or some other means of accommodating the vertical motion. The torque transmitted through the drive train is extremely high, requiring very costly drive shafts and u-joints. In fact, to accommodate the torque requirements each drive pulley is driven on both ends of its shaft.

Thus, there is a need to create a traction style tensioning machine that is inherently less expensive and can be serviced with significantly reduced downtime and which overcome the above-mentioned deficiencies and others while providing better overall results.

### SUMMARY OF THE DISCLOSURE

In accordance with one embodiment of the disclosure, a pair of traction tension machine processes a range of strip thicknesses.

In accordance with another embodiment of the disclosure, a traction tension machine is provided that is inherently less expensive and can be serviced with significantly reduced downtime.

In accordance with another embodiment of the disclosure, the traction machine includes groups of upper padded roller chain assemblies and groups of lower padded roller chain assemblies.

In accordance with another embodiment of the disclosure, the upper padded roller chain assembly has strands which have a series of resilient and removable pads, each mounted in a metal pad carrier. The metal pad carrier is part of a roller chain link that utilizes a pair of rollers with sealed bearings. This creates a roller chain with elastomeric pads.

In accordance with another embodiment of the disclosure, there are several rows of padded roller chains across the face width of the machine such as two groups of three chains and three groups of two chains that add up to a total of twelve roller chains across the face width. The upper entry pulley has twelve rows of sprocket teeth that engage the twelve roller chains.

In accordance with another embodiment of the disclosure, twelve chain tracks and twelve chain tensioning track segments are each mounted on a common moveable chain carrier platen.

In accordance with another embodiment of the disclosure, each of the elastomeric pads is individually removable, and each of the twelve chains are individually removable. The technique is similar for the upper chains and the lower chains.

In accordance with another embodiment of the disclosure, described is a traction tensioning device including at least one upper chain assembly driven by an upper pulley; at least one lower chain assembly driven by a lower pulley, wherein each of the upper and lower chain assemblies has a plurality of pads mounted to the chain assemblies. The upper chain assembly is mounted to a movable platen. The lower chain assembly is mounted to a fixed platen. The upper chain assembly and the movable member move with respect to the lower chain assembly thereby creating a squeeze/clamping on the strip. The clamping force allows a pair of these machines to be used to create high tension in the strip. This is done by running the exit traction machine at a controlled speed that is slightly higher than the speed of the entry traction machine. The high tension in the strip pulls against the traction machines. It takes very high clamping force to keep the strip from slipping through the clamp zone in each traction machine.

In accordance with another embodiment of this disclosure, described is a traction tensioning device having at least one upper chain assembly driven by an upper pulley; at least one lower chain assembly driven by a lower pulley, and an upper movable track member and a lower movable track member. The upper chain assembly engages the upper movable track member and the lower chain assembly engages the lower movable track member, wherein at least one of the upper movable track member and the lower movable track member is moved to tension the chain assembly that engages it.

In accordance with another embodiment of the disclosure, a pair of traction tension machines can provide enough clamping force on the strip to resist a pull of about 500,000 pounds of tension.

Still other aspects of the disclosure will become apparent upon a reading and understanding of the following detailed description.

### BRIEF DESCRIPTION OF THE DRAWINGS

FIG. 1 is a side elevational view of an existing leveling mill having entry bridle rolls and exit bridle rolls.

FIG. 2 is a perspective view of an existing stretching machine for creating high tension in thick strip.

FIG. 3 is a side elevational view of an existing traction device.

FIG. 4 is a perspective view of an existing traction device.

FIG. 5 is a front elevational view of an existing traction device.

FIG. 6 is a perspective view of a traction device in accordance with a preferred embodiment of the disclosure.

FIG. 7 is a side elevational view of the traction device of FIG. 6.

FIG. 8a is a front elevational cross-sectional view showing pulleys of the traction device of FIG. 6.

FIG. 8b is a front elevational view showing the padded roller chains of the traction device of FIG. 6.

FIG. 9 is a perspective view of an upper padded roller chain assembly of the disclosure.

FIG. 10 is a side elevational view of a padded roller chain of the disclosure.

FIG. 11 is a cross-sectional view of padded roller chains along lines A-A of FIG. 10.

FIG. 12 is a front perspective view of chain tracks along a width for the tensioner of the disclosure.

FIG. 13 is a side elevational view of the traction tension assembly of the disclosure.

### DETAILED DESCRIPTION OF THE DISCLOSURE

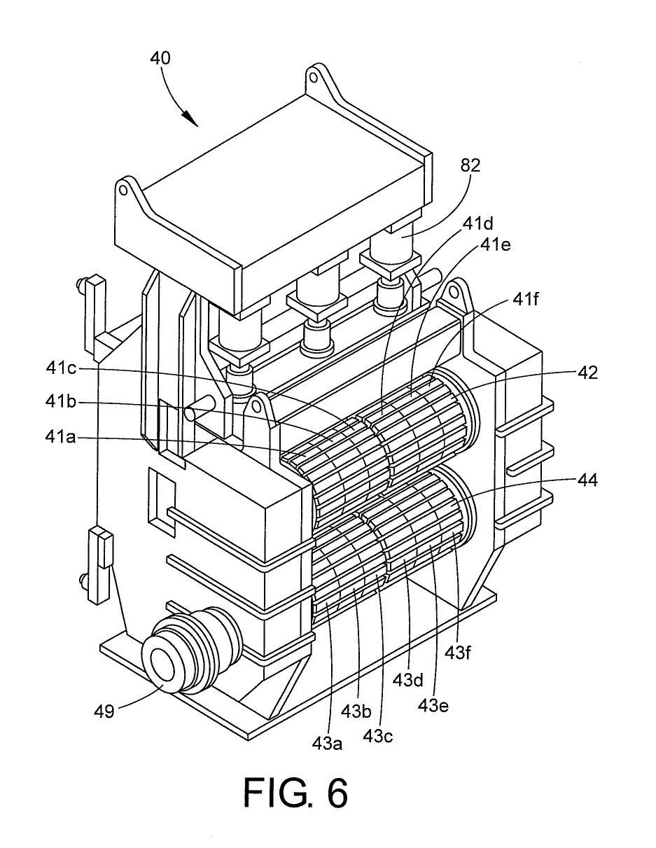

Referring now to FIGS. 6, 7, 8a and 8b, a preferred embodiment of the disclosure is shown. A traction tensioning machine 40 includes groups 42 of upper padded roller chain assemblies 41 and groups 44 of lower padded roller chain assemblies 43.

The upper padded roller chains 41 are wrapped around an upper driven sprocket toothed pulley 46 having sprocket teeth 65. In a similar fashion the lower padded roller chains 43 are wrapped around a lower driven sprocket style pulley 48 having sprocket teeth 67.

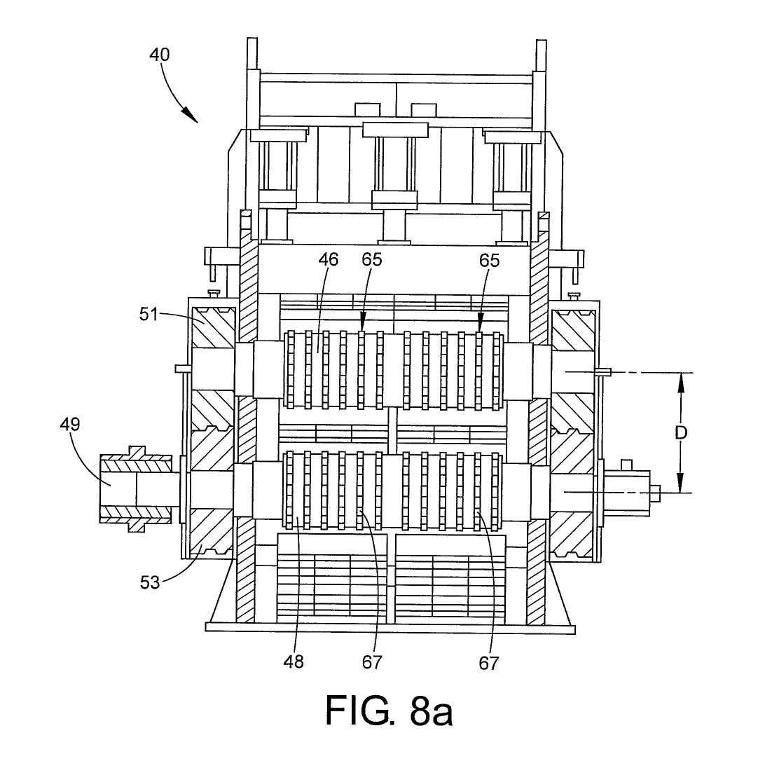

FIG. 8a shows there is a fixed vertical center distance D between the upper (46) and lower (48) sprocket toothed pulleys. The center distance D between these pulleys is established by the assembled design, and does not change during operation.

Because the vertical distance between the entry pulleys is fixed, it is possible to gear the pulleys to each other with a pair of pinion gears 51, 53 that are in constant engagement with each other. The lower sprocket pulley has an input shaft 49. Not shown, but directly coupled to the input shaft is a reduction gearbox and motor. This drive arrangement is accomplished without the use of any drive shafts or u-joints. Physically, these drive components need to impart very high torque values. This preferred embodiment accomplishes the purpose without the use of expensive drive shafts and u-joints. A pair of entry and exit traction units are identical and can be driven from either side of each machine.

In a preferred embodiment of this disclosure, there is a fixed vertical center distance D between the upper sprocket 46 and lower sprocket 48 which stays constant. This allows gears 51 and 53 to stay in mesh, thus eliminating the need for drive shafts (which at these torque levels are very expensive). The opening and closing of the upper padded chain assemblies 41 is handled by movable platen 80. It is moved by six cylinders 82. It is also preferred that upper sprocket pulley 46 is mounted (i.e., fixed) elevated relative to an incoming strip of material. This creates a “throat” that guides the strip into the clamp zone between the upper and lower pads 52 and sprockets 46, 48. It is also important that during this threading of the strip, cylinders 82 are kept at low pressure, which allows various thickness of strip to thread properly. Once the strip has passed through the clamping zone, pressure is increased to the max.

Referring to FIGS. 6 and 8b, there are several rows of upper padded roller chains 41 and lower padded roller chains 43 across the face width of the machine. For example, in the preferred embodiment, there are two groups of three chains in the upper chain assembly and in the lower chain assembly adding up to a total of six upper roller chains 41a, 41b, 41c, 41d, 41e, 41f and six lower assembly chains 43a, 43b, 43c, 43d, 43e, 43f across the face width of the device.

Referring to FIG. 8a, the upper drive pulley 46 has twelve rows of sprocket teeth 65 that engage the six roller chains 41a-41f. Lower drive pulley 48 also has twelve rows of socket teeth 67 that engage six roller chains 43a-43f.

Each cleat/pad 52 has a resilient layer that touches the strip. The resilient layer provides a relatively high friction factor and does not mark the surface of the strip. The resilient layer on the cleats/pads is subject to wear. Because the machine processes a wide range of strip widths, the wear is not uniform across the entire width of the machine. If full width cleats are used, entire cleat widths have to be replaced even if the wear is only in a narrow width zone. This makes full width cleat replacement expensive and time consuming. The multiple strands of narrow cleats is a big advantage, and a big design differentiator versus the existing machines that are out there. When worn, entire cleats need to be replaced even if the wear zone is limited to a fraction of the face width of the cleat. Cleat replacement can be expensive and time consuming.

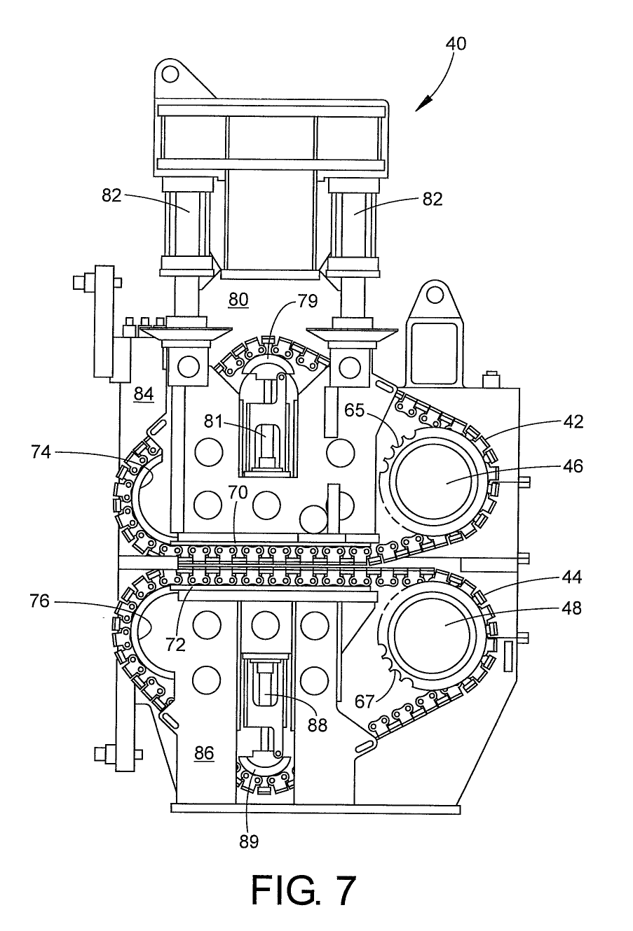

Referring to FIG. 7, as a given padded roller chain 41, 43 exits the sprocket toothed drive pulley 46, 48, the chain rollers ride a hardened plate 70, 72 that forms a horizontal path for the chains and is further formed into an exit radius path 74, 76 with machined tracks. These radiused tracks 74, 76 serve as a means of redirecting the chain towards moveable radiused track segments 79, 89. These moveable segments 79, 89 serve as chain tensioners. These tension segments 79, 89 further direct the chain towards the driven sprocket toothed pulley. The chain tracks are slightly wider than the face width of the chain rollers.

Referring still to FIG. 7, for the upper assembly, all six of the chain assemblies 41a-41f and all six of the chain tensioning segments or track members 79 are mounted on a common moveable chain platen 80. The upper sprocket toothed pulley 46 is not part of the moveable platen 80.

The upper chain platen 80 is guided and constrained in its movements utilizing shimmable guide rollers and liners. A total of six (6) hydraulic nip force cylinders 82 are attached between the upper chain platen 80 and the machine fixed housing 84. When the hydraulic cylinders are extended, the resultant action pushes the moveable upper chain platen 80 towards lower fixed chain platen 86 creating a vertical clamping force on strip that is passing between the upper and lower padded chains.

The strip of material passes between upper and lower pads 52 of upper and lower chains in a horizontal fashion, and does not take any wrap angle around the elastomeric pads 52.

Referring to the lower padded roller chain path, the chain 44 exits the pulley 48 in a horizontal fashion with the rollers guided on hardened liners 72. The chain then approaches a radius track 76, takes a partial wrap around the track and reverses back toward a radiused moveable chain tensioning segment 89. For the lower chain path, the sprocket toothed pulley is at the same vertical elevation as the hardened liners 74. The chain then wraps around the radiused tensioning segment 89 and continues on to the drive pulley.

The upper chain path is similar to the lower chain path arrangement, except the upper chain sprocket toothed pulley 46 is placed vertically higher than the upper exit radius 74. This creates a “throated” zone as the upper padded chains 41 exit the upper pulley 46.

During threading of the strip, the leading edge of the strip enters this throated zone, which serves as a funnel to direct the strip down towards the horizontal work zone. This also allows the upper platen 80 to be raised utilizing the retracting stroke of the nip force cylinders 82 to allow material to pass through the machine.

The upper and lower chain clusters 42, 44 are driven by their respective sprocket toothed pulleys 46, 48. The lower padded chain clusters ride across lower fixed platen chain liners 72. The chain rollers ride the liners with minimal friction loss. A radius chain tensioning track segment 89 is moveable vertically relative to the fixed platen structure 86. A group of hydraulic cylinders 88 vertically push against the radius track segment 89 which in turn pushes against the roller chain to keep it tensioned for proper chain function. This action is independent of the hydraulic squeeze force coming from the upper chain nip force cylinders 82.

The upper chain cluster 42 passes horizontally under the upper moveable platen tracks 70. The chain rollers ride the upper padded chains across the upper tracks with minimal friction loss. A group of vertical hydraulic cylinders 81 keep the upper chains properly tensioned in a fashion similar to the lower chain tensioning system.

When in use, the hydraulic cylinders 82 push down on upper chain platen 80. This closes the gap between the upper and lower padded chains. During threading of the strip, the hydraulic cylinders 82 close the gap at low hydraulic pressure. When the leading edge of the strip is forced into the gap between the upper and lower pads 52, the upper moveable platen 80 is pushed up against the low pressure of hydraulic cylinders 82, by the strip to accommodate the strip thickness. Once the strip is threaded through the machine, the hydraulic pressure in cylinders 82 is increased and the strip is clamped between upper and lower pads 52 of upper and lower chains 41, 43.

Each of the elastomeric pads 52 are individually removable, and each of the six upper and six lower chains are individually removable. The technique is similar for the upper chains and the lower chains.

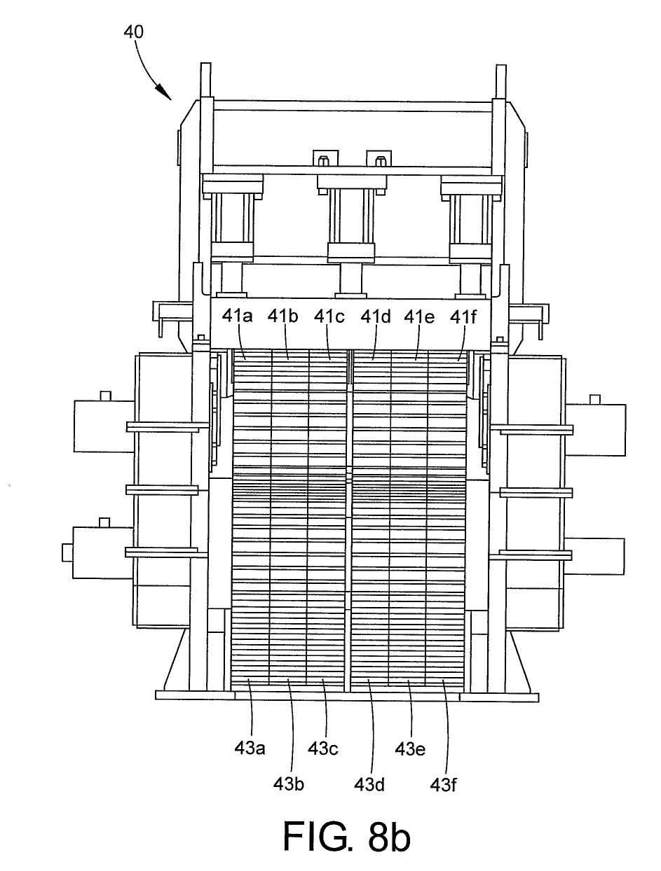

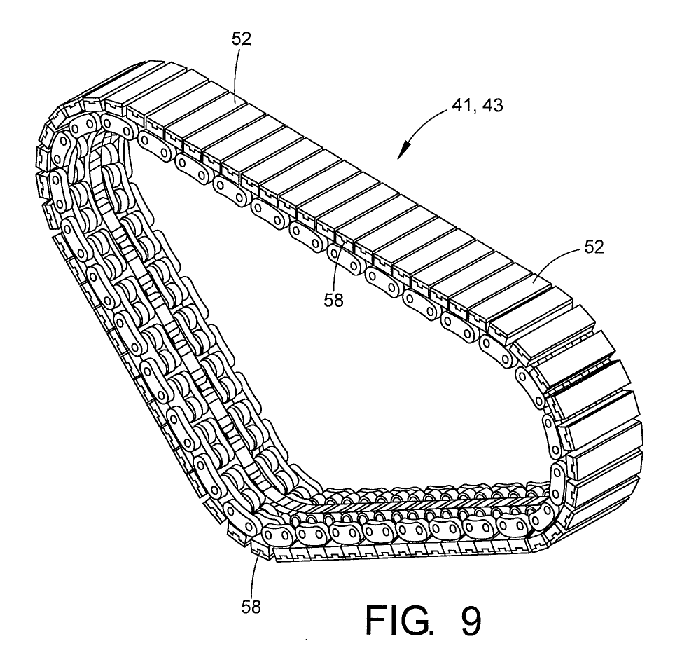

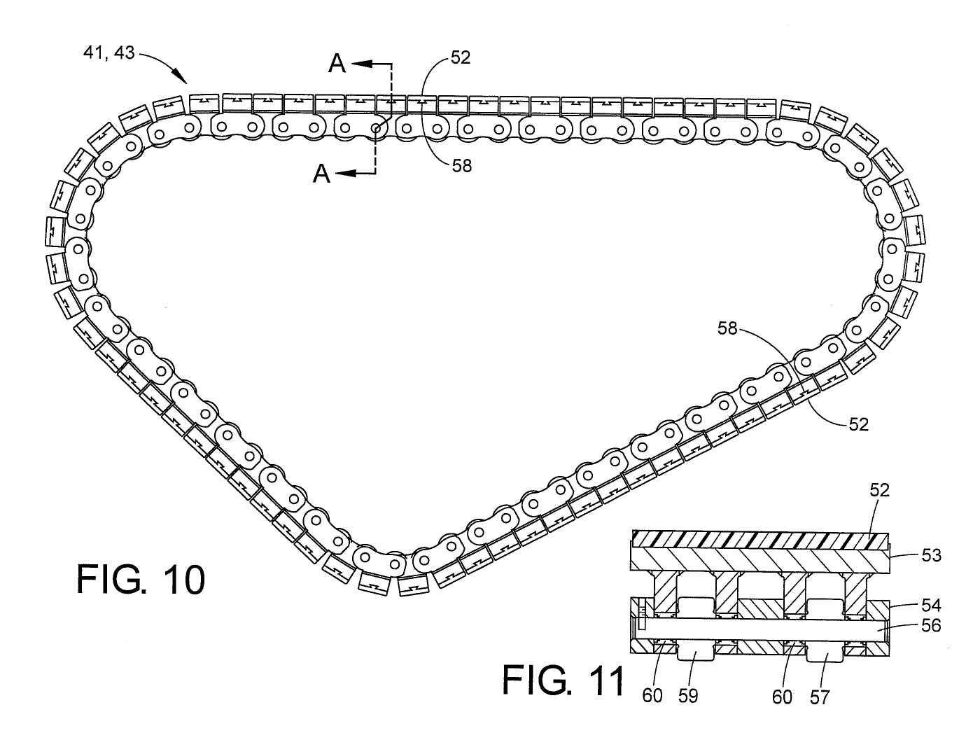

Referring now to FIGS. 9-12, details of a padded roller chain assembly 41, 43 are shown. Each strand includes a series of resilient and removable pads 52, each mounted in a male metal chain block 53 and female metal chain block 54 (FIG. 11). The chain blocks are part of a roller chain that utilizes a pair of sealed rollers 57, 59 with bearings and sealed needle bearings 60 on each side of each roller. A single shaft 56 runs the width of the chain segment connecting the male and female chain blocks 53, 54. This design in effect creates a roller chain with elastomeric pads.

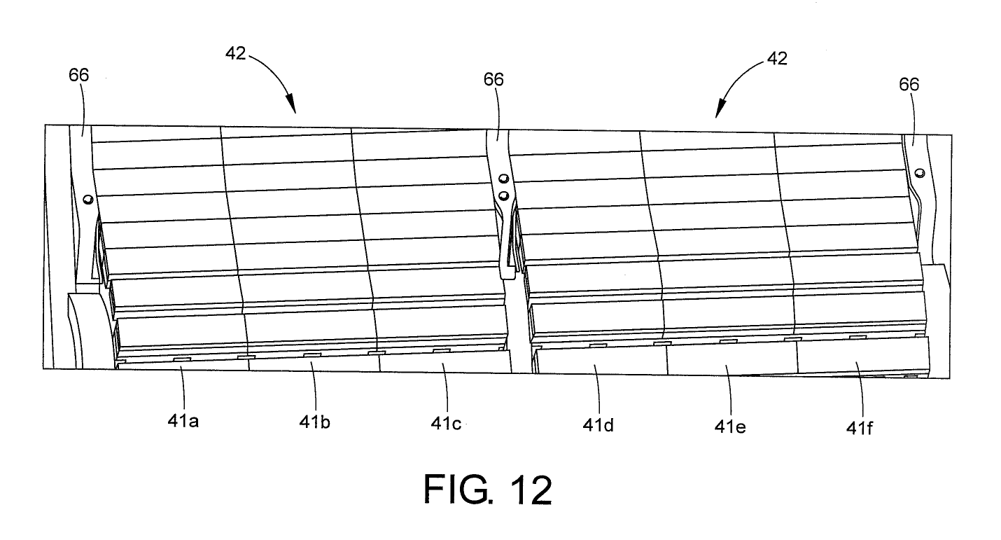

Each of the elastomeric pads 52 are preferably retained in a slot or pocket 58 in the metal chain blocks. The pocket geometry of the chain blocks retains the pad in all directions except axially. The pocket 58 for retaining the cleat chain can be a dovetail design as shown or alternatively can be a different pocket design. During operation the axial location of the pad 52 is maintained as the chain travels throughout the path with rollers 66 located in the frame as shown in FIG. 12. A roller 66 is located on either side of each set of three chains. This restrains the pads 52 while allowing pads to be removed in areas where there is access to the sides of the pads. There are several sets of rollers 66 staged along the path of the padded chains.

When in use, the elastomeric pads 52 will wear at different rates dependent on the range of strip widths that are processed. A given series of worn pads can be readily removed and replaced without replacing all the other pads. This is accomplished by sliding a worn pad out of its chain block.

Referring now to FIG. 12, the placement of center roller 66, allows a gap to exist between adjacent groups of padded roller chains 42. This gap allows attachment points to pass through the gap and a given attachment point is fitted with hydraulic cylinder 82. There are also two attachment points located on each side of the roller chain groups with hydraulic cylinder 82 attachment points as well.

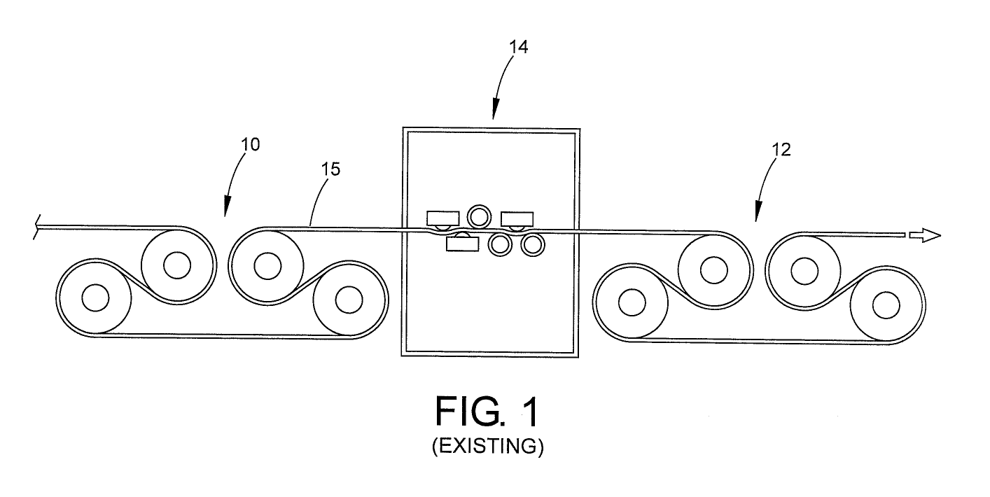

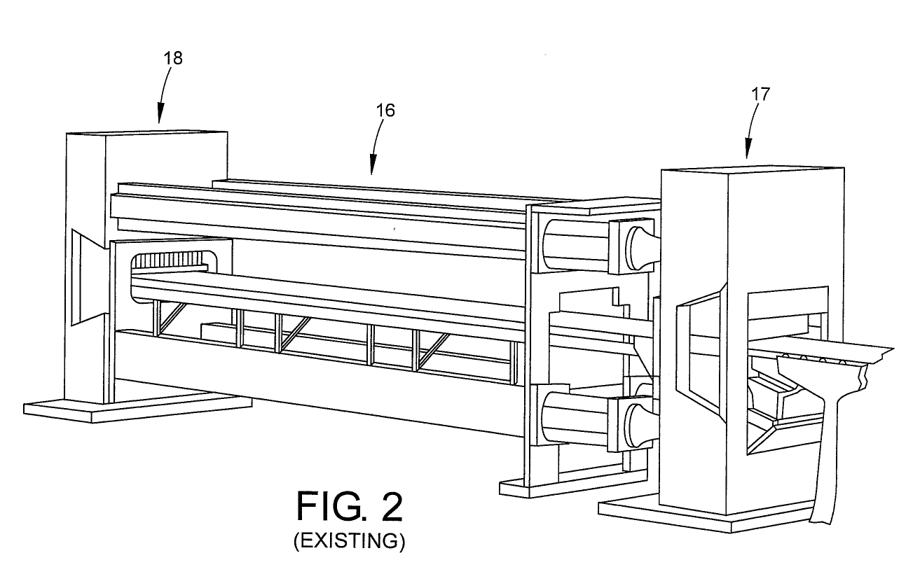

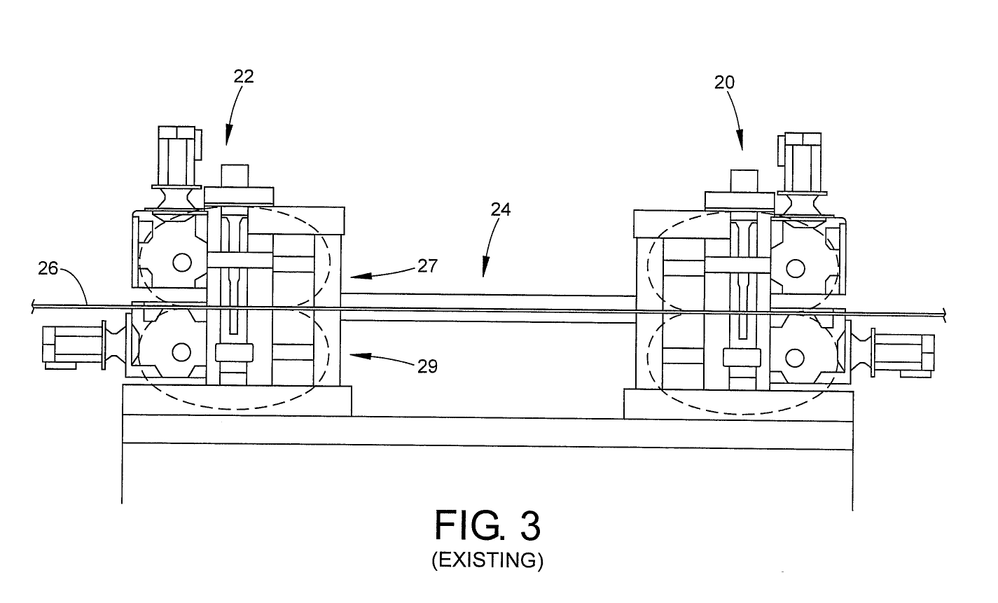

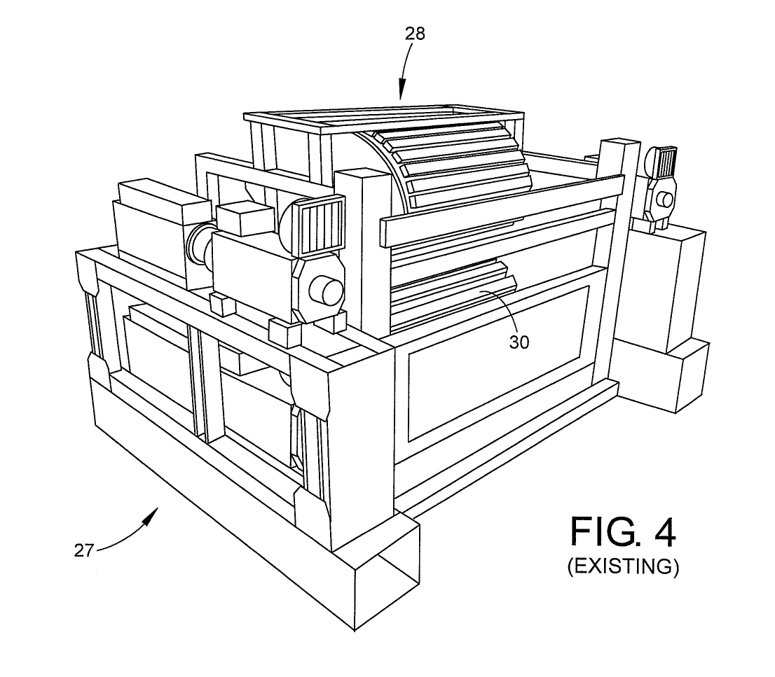

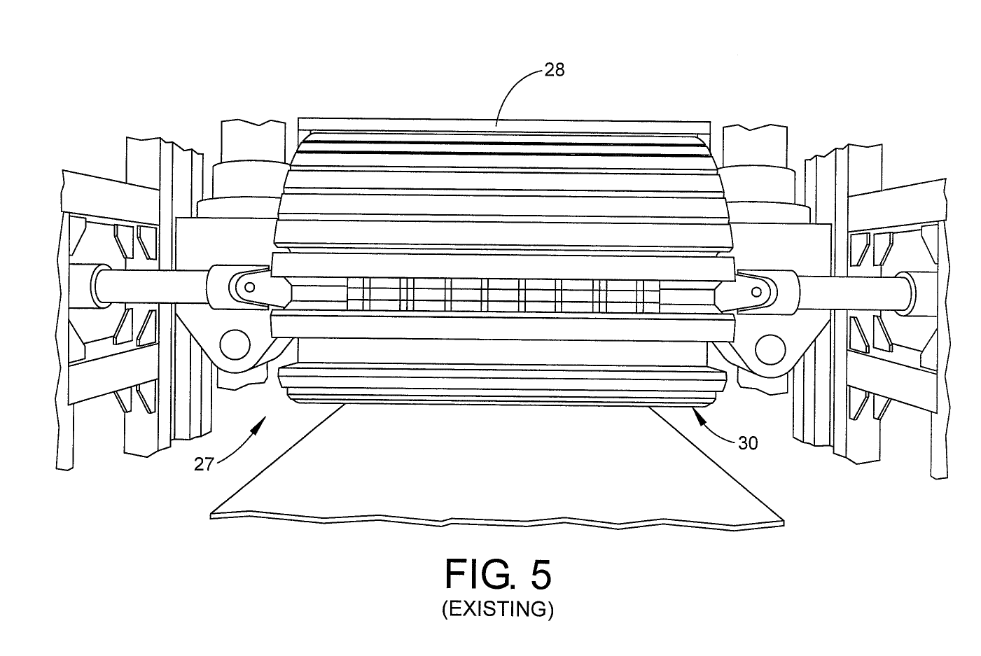

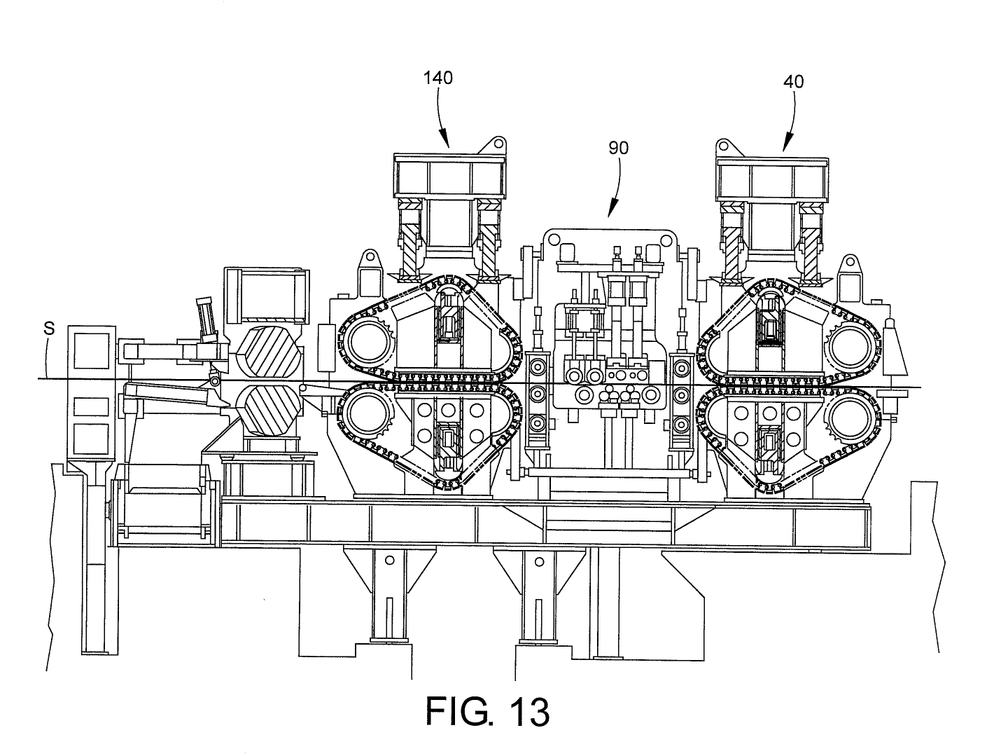

Referring to FIG. 13, a pair of traction heads 40, 140 is shown with a tension leveler (i.e., roller leveler) 90 in a high tension zone between the two heads. The tension leveler is typically between entry and exit bridles as shown in FIG. 1. The traction tensioning heads shown in FIG. 13 replace the bridles.

Both traction machines 40, 140 are driven by very high horsepower motors. The exit machine 40 is driven a fraction of a percentage faster than the entry machine 140 thus creating a high tension in the strip that is between the two heads (see FIG. 13). It takes machine 40 and machine 140 to create the tension in the strip. Item 90 is in the high tension zone. As the strip passes through the work rolls in zone 90, the strip is “bent” over and under the rolls. This additional bending stress combined with the tension stress, yields the material in a very controlled manner. Comparing to FIG. 1, the results are the same. The pair of traction machines 40, 140 replace bridle roll clusters 10 and 12 of FIG. 1. With the traction machines 40, 140 the strip is not bent around bridle rolls (like in FIG. 1). This enables the traction machines to process thicker strip than the bridle rolls allow. The strip exiting the system needs to be flat. In FIG. 1, the bridle rolls would need to be very large in diameter to bend thick strip and not yield it based on the roll diameter.

The exemplary embodiment has been described with reference to the preferred embodiments. Obviously, modifications and alterations will occur to others upon reading and understanding the preceding detailed description. It is intended that the exemplary embodiment and appended claims be construed as including all such modifications and alterations insofar as they come within the scope of the embodiment or the equivalent thereof.

1. A traction tensioning device comprising:
at least one upper chain assembly driven by an upper pulley;
at least one lower chain assembly driven by a lower pulley,
wherein each of said at least one upper and lower chain assemblies comprises a plurality of pads mounted to said chain assemblies;
wherein said upper chain assembly is mounted to a movable platen member;
wherein said lower chain assembly is mounted to a fixed platen member;
wherein said upper chain assembly and said movable platen member raises and lowers with respect to said lower chain assembly thereby creating a clamping force on an associated strip of material passing between said upper and lower chain assemblies.

2. The traction tensioning device of claim 1, wherein said movable platen member is raised or lowered by at least one hydraulic arm.

3. The traction tensioning device of claim 1, wherein said movable platen member comprises a curved member on which said upper chain assembly moves.

4. The traction tensioning assembly of claim 1, wherein a pair of guide members are positioned opposite each other and provide a horizontal path on which said upper and lower chain assemblies move.

5. The traction tensioning device of claim 4, further comprising an upper movable curved segment which moves with respect to said movable platen member to provide tension to said associated upper chain assembly.

6. The traction tensioning device of claim 5, further comprising a lower movable curved segment which moves with respect to said lower fixed platen member to provide tension to said lower chain assembly.

7. The traction tensioning device of claim 1, wherein said at least one upper chain assembly comprises two groups of three chain assemblies positioned across the width of said traction tensioning device.

8. The traction tensioning device of claim 1, wherein said at least one lower chain assembly comprises two groups of three chain assemblies positioned across the width of said traction tensioning device.

9. The traction tensioning device of claim 1, wherein said upper and lower chain assemblies comprise a plurality of pads mounted on at least one of a male and female mounting block.

10. The traction tensioning device of claim 1, wherein said pads comprise elastomeric pads.

11. The traction tensioning device of claim 1, wherein a fixed vertical distance between said upper pulley and said lower pulley enables a first upper gear and a second lower gear to remain engaged.

12. The traction tensioning device of claim 1, wherein said upper pulley is elevated and fixed relative to an associated incoming strip to allow the associated strip to enter between the upper and lower chain assemblies.

13. A traction tensioning device comprising:
at least one upper chain assembly driven by an upper sprocket;
at least one lower chain assembly driven by a lower pulley,
an upper movable track member and a lower movable track member, wherein said upper chain assembly engages said upper movable track member and said lower chain assembly engages said lower movable track member, wherein at least one of said upper movable track member and said lower movable track member is moved to provide tension to its respective chain assembly.

14. The traction tensioning device of claim 13, wherein said upper movable track member and said lower movable track member are moved by at least one hydraulic arm.

15. The traction tensioning device of claim 13, further comprising a movable platen to which said upper movable track member is mounted, wherein said movable platen is raised or lowered by another at least one hydraulic arm.

16. The traction tensioning device of claim 15, wherein said movable platen comprises a curved member on which said upper chain assembly moves.

17. The traction tensioning assembly of claim 13, wherein a pair of guide members are positioned opposite each other and provide a horizontal path on which said upper and lower chain assemblies move.

18. The traction tensioning device of claim 13, wherein said at least one upper chain assembly comprises two groups of three chain assemblies positioned across the width of said traction tensioning device.

19. The traction tensioning device of claim 13, wherein said at least one lower chain assembly comprises two groups of three chain assemblies positioned across the width of said traction tensioning device.

20. The traction tensioning device of claim 13, wherein said upper and lower chain assemblies comprise a plurality of pads mounted on a mounting block.
